(19) United States
(12) Patent Application Publication
(10) Pub. No.: US 2020/0117201 A1
(43) Pub. Date: Apr. 16, 2020

(54) METHODS FOR DEFINING WORK AREA OF AUTONOMOUS CONSTRUCTION VEHICLE

(71) Applicant: Caterpillar Paving Products Inc., Brooklyn Park, MN (US)

(72) Inventors: Nicholas A. Oetken, Brooklyn Park, MN (US); Timothy M. O'Donnell, Long Lake, MN (US)

(73) Assignee: Caterpillar Paving Products Inc., Brooklyn Park, MN (US)

(21) Appl. No.: 16/160,825

(22) Filed: Oct. 15, 2018

(51) Int. Cl. G05D 1/02; G05D 1/00; B64C 39/02; G06K 9/00

(52) U.S. Cl. CPC G05D 1/0214; G05D 1/0044; B64C 39/024; G05D 1/0285; G06K 9/0063; G02B 27/0172; B64C 2201/141; B64C 2201/146; B64C 2201/123; B64C 2201/027; G05D 2201/0202; G06K 9/00671

(57) ABSTRACT

A method for defining a work area for an autonomous industrial vehicle comprises positioning an optical surveying device, such as a headset or UAV incorporating a LIDAR system, within a work area, viewing work area landmarks within the work area via the optical surveying device, establishing virtual work area markers about the work area using the optical surveying device, and establishing work area boundaries from the work area markers within an image of the optical surveying device. Viewing work area landmarks can comprise scanning topographical features of the work area with an unmanned aerial vehicle to generate a three-dimensional terrain map of the work area from the topographical features.

### TECHNICAL FIELD

The present application relates generally, but not by way of limitation, to systems and methods used in defining work areas for machines that can be used in various industrial applications, such as paving, agricultural, construction and earth-moving operations. More particularly, the present application relates to systems and methods for defining work areas for autonomous vehicles used in various outdoor industrial applications.

### BACKGROUND

A typical system for paving a work area such as a parking lot or road can include numerous different machines. Supply machines such as haul trucks may be used to deliver paving material for distribution and compaction on a work surface. Paving machines can be supplied directly from the haul trucks, or from material transfer vehicles. Paving machines typically distribute paving material and perform a preliminary compaction of a “mat” of paving material with a screed mounted at the back end of the paving machine. In many systems, the paving machine is followed closely by a compacting machine known in the art as a breakdown roller. Another compacting machine known as an intermediate roller often follows the breakdown roller, and a final finish roller can follow behind the intermediate roller in some systems. In some cases, soil compaction can occur before the paving machine lays the mat, such as with a soil compactor.

Such system are sometimes referred to as a “paving train” because the vehicles follow each other in-line in close proximity. Soil compaction can take place before and separate from the paving train operations. Therefore, operation of each machine must be carefully manned and monitored by operating personnel. The operator of the lead vehicle typically follows the desired route for laying of the mat, which can be evaluated in real time by the driver of the lead vehicle. The operators of each subsequent vehicle maintain the same route by following the vehicle directly in front with proper spacing. Before each job performed by the paving train, the work area for the machines can be defined with a manual process, such as by referencing a map or construction plans of a work site. Operators of the machines typically actively drive the machines to maintain the vehicles safely within the work area to, for example, eliminate driving on potentially hazardous terrain and avoiding other potential no-go areas where people or property can become injured or damaged.

Publication No. US 2017/0277180 A1 to Baer et al., entitled “Unmanned Surveyor,” and U.S. Pat. No. 9,233,751 to Metzler, entitled “Geodetic Marking System For Marking Target Points,” disclose various systems and methods for surveying work areas.

### SUMMARY OF THE INVENTION

A method for defining a work area for an autonomous industrial vehicle can comprise positioning an optical surveying device within a work area, viewing work area landmarks within the work area via the optical surveying device, establishing virtual work area markers about the work area using the optical surveying device, and establishing work area boundaries from the work area markers within an image of the optical surveying device. Viewing work area landmarks within the work area can comprise scanning topographical features of the work area with an unmanned aerial vehicle to generate a three-dimensional terrain map of the work area from the topographical features.

### BRIEF DESCRIPTION OF THE DRAWINGS

FIG. 1 is a diagrammatic illustration of an autonomous paving train according to an embodiment of the present disclosure.

FIG. 2 is diagrammatic illustration of a construction site in which an aerial drone and an augmented reality headset can be used to survey and define a work area within the construction site.

FIG. 3 is a diagrammatic illustration of a display screen generated by one or both of the drone and headset of FIG. 2 showing a defined work area within the construction site.

FIG. 4 is a diagrammatic illustration of a user interface for a control station or a construction vehicle showing a course for an autonomous vehicle plotted within the defined work area of FIG. 2.

FIG. 5 is a schematic illustration of an unmanned aerial vehicle for use with the systems and methods described herein.

FIG. 6 is a schematic illustration of an augmented reality headset for use with the systems and methods described herein.

### DETAILED DESCRIPTION

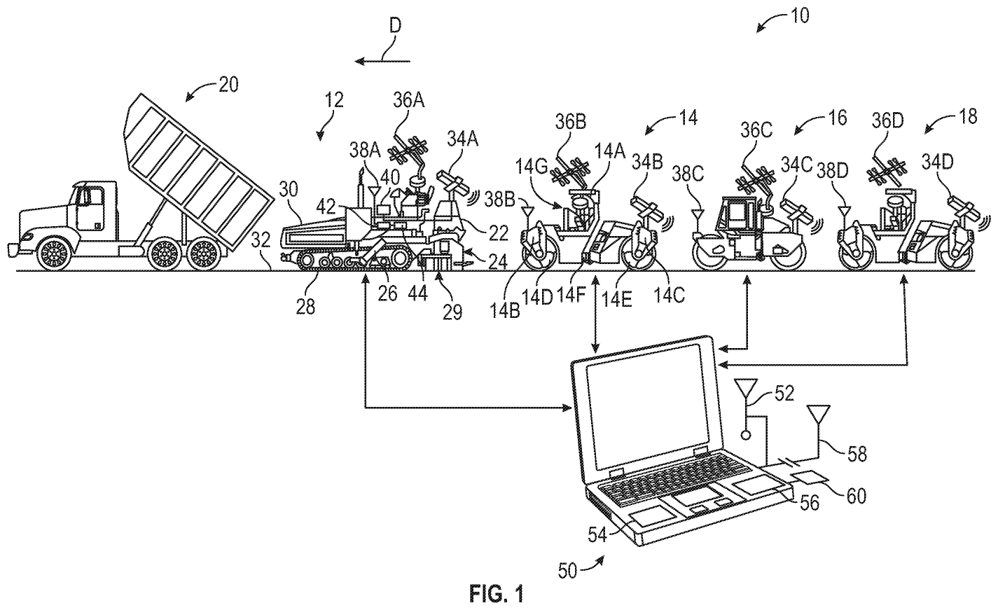

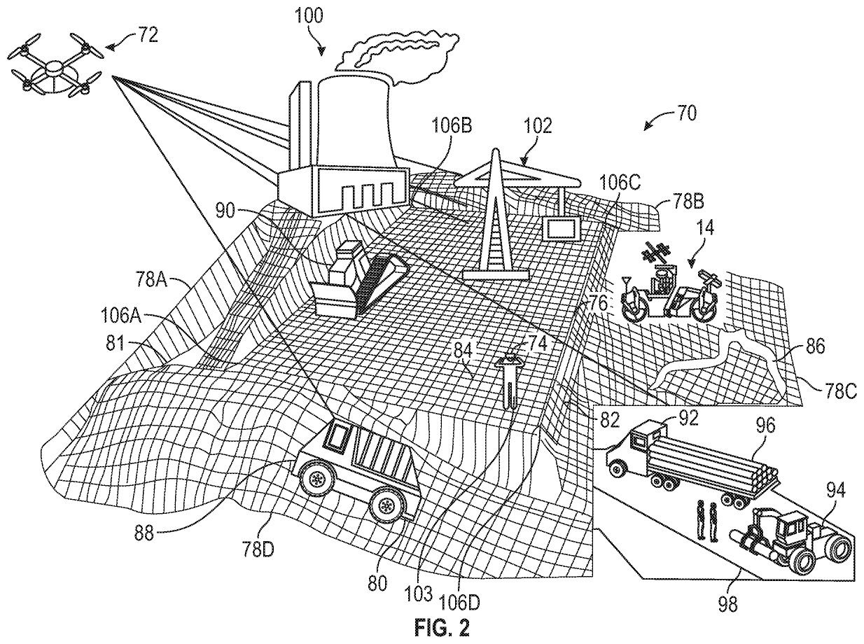

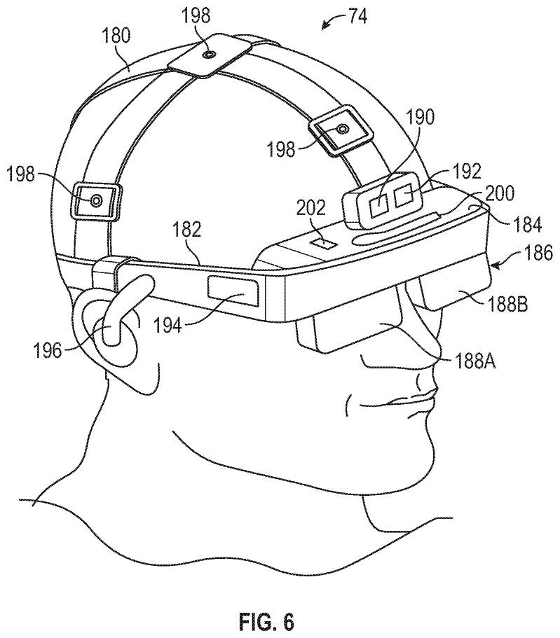

FIG. 1 is a diagrammatic illustration of autonomous paving train 10 according to the present disclosure. Paving train 10 can comprise one or more machines, such, as paving machine 12, compactor machines 14, 16 and 18, and supply machine 20. Paving operations can take place after soil compaction is performed with a compactor machine similar to compactor machines 14, 16 and 18. Each of the machines of paving train 10 can be configured to autonomously interact with a paving material, typically performing a particular type of work thereon. For example, a route for paving train 10 can be programmed into control station 50, which can communicate with each of the vehicles of paving train 10. as described below. The route for paving train 10 can be planned based on a work area defined for a particular job. The work area can be defined to provide a safe area for the autonomous machines to operate without risk of harming any other equipment or people and without putting the autonomous vehicle in a compromising position, e.g., on too steep of a grade. In various examples, the work area for paving train 10, or any individual machine thereof, can be defined by an unmanned aerial vehicle (UAV) or drone, such as drone 72 of FIGS. 2 and 5 or an augmented reality headset, such as headset 74 of FIGS. 2 and 6.

Typically, a work area is defined manually by personnel for paving train 10 that, for example, walk or ride around a construction site manually tracing boundaries for the paving train. For example, landmarks along the way can be electronically marked with, for example, a Global Positioning System (GPS) unit. Coordinates for the landmarks can then be programmed into a useable format for the machines to follow a route. Such a process can be very time consuming, especially in particular contexts. For example, in autonomous road paving operations, the work area is very long and narrow. Thus, manually tracing the work area can often consume about twenty-five percent as much time as the actual paving operation. Also, at building site work areas, such as where large facilities such as power plants are being constructed, the work area can change on a day-to-day or hour-to-hour basis as construction equipment and material are moved around the work area. As such, the present inventors have recognized that considerable time savings, and associated financial savings, can be obtained by more expediently defining the work area for autonomous construction vehicles and system, such as paving trains. In various examples, a work area for paving train 10, as well as for other construction equipment and systems, can be defined via the use of an optical surveying device that can view landmarks within the work area remotely, i.e., without requiring an operator to visit the actual location of each landmark within the work area, and that can determine a position of each landmark to define work area boundaries for the autonomous machine or system. The optical surveying devices described herein are particularly useful for defining the work area of a soil compactor where a lead paving machine is not leading other compaction machines. In the present disclosure, various optical surveying devices, such as range finders, LIDAR, lasers, monocular, stereo cameras, position sensors, orientation sensors and inclination sensors, sensors, can simultaneously generate three-dimensional maps of the work area within the boundaries of the landmarked work area, which can then be used to automatically generate routes within the work area that do not drive through avoidance areas, such as hazardous terrain. In examples, the optical surveying devices can be included in augmented reality headsets or unmanned aerial vehicles.

While only certain machines are shown in FIG. 1, it should be appreciated that for relatively large paving jobs, additional paving machines, additional compactors, supply machines, etc. can be part of system 10. Moreover, while in many embodiments system 10 will be used in paving one particular work area, such as a stretch of road, a parking lot, etc., in other embodiments, additional machines at other work areas may be part of a large integrated paving system that includes the machines of system 10 shown in FIG. 1. Additionally, in other embodiments, other types of construction equipment, such as bulldozers, excavators, graders and the like can be autonomously controlled as described herein.

One or more supply machines 20, such as a haul truck, a material transfer vehicle, etc., can supply paving material for paving a work surface to the other machines of system 10. Paving machine 12 can comprise vehicle portion 22, which can be connected to screed system 24 via tow arm 26. Vehicle portion 22 can additionally comprise propulsion element 28, auger system 29 and hopper 30. Loose paving material from supply machine 40 can be deposited onto work surface 32. Work surface 32 can comprise a base course upon which a top wear course can be applied, such as a mat. Paving machine 12 can include means for moving loose paving material into hopper 30, such as an elevator as is known in the art. Paving material can be asphalt, aggregate materials or concrete. In various embodiments, paving material can be deposited directly into hopper 30 of paving machine 12. Paving machine 12 can travel in direction D, while a conveyor system within or underneath hopper 30 can move paving material in the opposite direction from hopper 30 to auger system 29.

Paving machine 12 can further include sensor 34A, receiver 36A, transmitter 38A, display device 40, memory 42 and electronic control unit 44. Sensor 344 can comprise any sensor suitable for use with system 10, such as a temperature sensor, a level sensor, a grade sensor, a positions sensor (e.g., a GPS sensor), or the like.

Receiver 364 can receive electronic signals, such as position data, for machine 12 from, for example, control station 50. Position data received via receiver 36A can include geographic position data such as GPS signals or local positioning signals, or position data indicative of a position of machine 12 relative to other machines of system 10. Position data can also comprise alert commands, navigation commands such as start commands, stop commands, machine speed commands, turning commands, steering commands and travel direction commands, conveyor speed commands, etc., can also be received via receiver 36A. Additionally, data signals from other machines of system 10 including machine position and spacing data.

Transmitter 384 can output control signals to other machines, or output other data signals, such as to control station 50 indicative of the actual position of paving machine 12 as determined from a sensor signal from sensor 34A.

Display device 40, such as an LCD display device, can be mounted to machine 12 for viewing by an operator. In an embodiment, display device 40 may be configured to display a map of a work area, including icons, etc. representing one or more of the machines of system 10.

A computer readable medium or memory 42, such as RAM, ROM, flash memory, a hard drive, etc., can also be mounted to machine 12 and be in communication with sensor 34A, receiver 36A, transmitter 38A and display device 40. In an embodiment, memory 42 can have program instructions comprising computer executable code recorded thereon for carrying out one or more of the control functions of the present disclosure, further described herein, Computer readable memory 42 can also be configured to have electronic data associated with operation of system 10 recorded thereon via a memory writing device.

Compacting machine 14 can comprise a “breakdown” roller which will ordinarily follow relatively closely behind paving machine 12, such that it can compact paving material distributed by paving machine 12 while the paving material is still relatively hot.

Compacting machine 14 can comprise operator cab 14A, frame units 14B and 14C, compacting drums 14D and 14E, articulation joint 14F and control unit 14G. In an embodiment, compacting machine 12 can be configured according to the compacting machine described in U.S. Pat. No. 8,116,950 to Glee, entitled “Machine System and Operating Method for Compacting A Work Area,” the contents of which are hereby incorporated in their entirety by this reference. Control unit 14G can cause a prime mover, such as an engine to rotate compacting drums 14D and 14E, which can propel machine 12 in direction D. Compacting drums 14D and 14E can be configured as is known in the art to compact material over which compacting drums 14D and 14E roll. For example, compacting drums 14D and 14E can include a fluid, such as water, or volume of solid particles, such as sand, inside that can be vibrated to compact the material of work surface 32. Control unit 14G can operate articulation joint 14F to steer compacting machine 12 while the prime mover is activated to move compacting machine 14. As such, control station 50 can operate control unit 14G to cause compacting machine to autonomously follow paving machine 12 or another route within a defined work area to avoid exclusion areas, as described herein, without the need for direct operator control. In an example, compacting machine 14 can receive steering instruction from control station 50 via receiver 36B to actively follow a route, or compacting machine 14 can receive the route via receiver 36B, which can contain a full set of steering instructions therein. Compacting machine 14 can include computer readable storage memory for storing steering and routing information that can be accessed by control unit 14G.

Compacting with machine 14 while paving material is hot allows machine 14 to perform a significant proportion of the total compaction desired for a particular lift of paving material, as hot asphalt in the paving material can easily flow and is thus readily compacted. In an embodiment, compacting machine 14 can be used primarily to compact paving material which has not yet cooled to a “tender zone” temperature range, which is a temperature range at which paving material moves or shoves in front of the advancing compactor drum, making attempted compaction generally undesirable.

Compacting machine 14 can further comprise sensor 34B, receiver 36B and transmitter 38B. Receiver 36B can receive position signals and/or control commands such as machine navigation signals, similar to paving machine 12. Sensor 34B can comprise any suitable sensor for use with compacting machine 14 Transmitter 38B can be mounted on machine 14 to transmit position data indicative of a relative or geographic position of machine 14, as well as electronic data acquired via sensor 34B. As such, compacting machine 14 can send and receive signals from, for example, control station 50 so as to be remotely or autonomously controlled.

Compacting machine 16 can comprise an intermediate roller which can compact paving material already compacted at least once by compacting machine 14 Compacting machine 16 can comprise sensor 34C, receiver 36C and transmitter 38C, each having functions which can be similar to that of the corresponding features of the other machines described herein. It will typically be desirable to compact paving material with machine 16 after the paving material has cooled to a temperature below the tender zone. Compacting machine 16 can include apparatus for sensing a smoothness and/or stiffness of paving material known to those skilled in the paving arts, and transmitter 38C can be equipped to transmit data which includes smoothness and/or stiffness data for use in system control and/or contract validation, etc., as described herein. Compacting machine 16 can send and receive signals from, for example, control station 50 so as to be remotely or autonomously controlled.

Compacting machine 18 can comprise sensor 34D, receiver 36D and transmitter 38D. Compacting machine 18 can comprise a finish roller which performs a final squeeze of the paving material in a particular lift, and may follow relatively closely behind compacting machine 16, in some instances, it will be desirable to compact paving material with compacting machine 18 prior to its cooling below a temperature in the range of about 0° C. to about 65° C. Compacting machine 18 can send and receive signals from, for example, control station 50 so as to be remotely or autonomously controlled.

In the illustrated embodiment, each of machines 14, 16 and 18 can transmit position and sensor data which can be processed via electronic control unit 44 and used in displaying various information via display device 40, and can be further used in controlling machine positioning, operation, and other factors as described herein. Paving machine 12 can serve as one command center at which paving progress is monitored and controlled, and data recorded, and from which control commands such as machine navigation signals to the other machines are transmitted. System 10 could alternatively be configured, however, such that any one of the other machines serves one or more of these functions, and in some embodiments a remote control station may be employed. Accordingly, the location and distribution of the various pieces of sensing equipment, data processing and recording, map display, etc., can be located on and controlled by one or all of machines 12, 14, 16 and 18.

As discussed above, control, monitoring and data recording relating to system 10 can take place from a variety of locations, either onboard one or all of machines 12, 14, 16, 18, 20 or at a separate command center. It is contemplated that for at least certain paving jobs, system 10 can be used with one or more control stations separate from each of the respective machines. Control station 50 can be a part of system 10, which can comprise a computer station monitored by a paving foreman, technician, etc., and can receive signals from any or all of the machines of paving system 10, and can be configured to output control commands to any or all of the machines of paving system 10. As discussed above, a control system can include an electronic control unit for processing electronic data generated during operation of system 10, and outputting appropriate control commands to vary or alter machine operation, as well as storing electronic data. Control station 50 can serve as an alternative or supplemental command center where personnel can monitor paying progress, view maps of the work area, etc. To this end, control station 50 can also include receiver 52, electronic control unit 54, memory 56 and transmitter 58. Electronic control unit 54 can also comprise memory writing device 60 configured to record electronic data from any of machines 12, 14, 16, 18 or 20 on memory 56. Control station 50 is illustrated in FIG. 1 as comprising a mobile computing device such as a laptop computer. However, in other embodiments, control station 50 can be comprise an off-site computing system that can process and analyze data from optical surveying devices 72 and 72 (FIG. 2) and that can be connected to a server on which data from optical surveying devices can be stored. In yet other embodiments, components and operations of control station 50, such as receiver 52, electronic control unit 54, memory 56 and transmitter 58 described below, can be incorporated directly into onboard control and computing systems of a vehicle, such as paver 12 or compactor 14. For example, electronic control unit 44 of paver 12 can include receiver 52, electronic control unit 54, memory 56 and transmitter 58.

Control station 50 can also be configured to communicate with supply machines and/or even an asphalt plant to speed up or slow down paving material production, delivery, etc., based on progress of paving system 10. In a related aspect, control station 50 can be used to control supply machine traffic by directing supply machines to a particular paving machine of system 10 or by directing supply machines to a particular job site. For example, if paving at one job site or by one particular paving machine is halted for any of a variety of reasons, it may be desirable to direct supply machines to locations where paving material is needed, or where excess paving material can be best accommodated, rather than stopping the supply chain. It should be appreciated that any or all of the control and data recording aspects of system 10 can take place at control station 50, via a laptop computer, a PDA, cell phone, etc. Thus, the control system can be located at least in part at control station 50, rather than on one of the machines of system 10. Typically, control station 50 can be in two-way communication with at least a portion of the machines of system 10, and also in one-way or two-way communication with machines and personnel associated with a supply chain for paving material.

In an embodiment, paving train 10 can be configured according to the systems and methods described in U.S. Pat. No. 8,099,218 to Glee et al, entitled “Paving System and Method,” the contents of which are hereby incorporated in their entirety by this reference.

Autonomous paving trains, such as paving train 10 and other soil compactors, can be configured to follow a predefined route within a predefined work area. That is, operators of paving train 10 or the soil compactor can, before a paving operation commences, electronically map a work area within a construction site to include external boundaries and internal avoidance area boundaries. Within the work area, the operators can plot out a route or course for paving train 10. With the present disclosure, the boundaries of the work area and the route within the work area can be obtained and prepared using electronic, optical surveying device incorporated into an unmanned aerial vehicle (UAV), or drone, or an augmented reality headset, as described with reference to FIGS. 2-6. The optical surveying device can, for example, use various light emitting or light capturing devices to sense, detect or measure distances, such as lasers, LIDAR, video cameras, photodetectors and the like, that can convert various distance measurements to topographical information associated with geographic location data. The route can be generated by automatically analyzing terrain data obtained by the optical surveying device to, for example, identify hazardous terrain features that should be avoided by various autonomous vehicles, thereby saving operator time in tracing work area boundaries and surveying terrain within said boundaries to identify grades, slopes, depressions and the like that autonomous vehicles should not attempt to traverse.

FIG. 2 is diagrammatic illustration of construction site 70 in which aerial drone 72 and augmented reality headset 74 can be used to survey and define work area 76 within construction site 70. Construction site 70 can be bordered by boundaries 78A, 78B, 78C and 78D, which can comprise natural barriers, roadways or parcel property lines. Within construction site 70, various terrain features can be located, such as incline or slope 80, ravine 81, drop-off 82, grade 84 and depression 86. Vehicles 88, 90, 92 and 94 can also operate within construction site 70. Vehicle 88 can comprise a supply machine, such as supply machine 20 of FIG. 1. Vehicle 90 can comprise a bulldozer. Vehicle 92 can comprise a truck for transporting construction material 96. Construction material 96 can, in the illustrated embodiment, comprise pipes for placement into ditch 98. Vehicle 94 can comprise a loader for moving pipes of construction material 96 into ditch 98. Also, various soil and pavement compactors can be operating within construction site 70, such as compactor machine 14. Additionally, various structures and building can be located within work area 76, such as existing structures and in-progress structures being actively worked-on within construction site 70. In the illustrated example, structure 100 comprises a power plant and structure 102 comprises a crane.

Drone 72, which can comprise an unmanned aerial vehicle, can be operated by personnel for paving train 10 or another construction machine system. For example, control station 50 can be utilized to maneuver drone 72 about the extent of construction site 70. Additionally, headset 74 can be operated by personnel for paving train 10 or another construction machine system. For example, person 103 can stand within construction site 70 to view the extent of construction site 70. Drone 72 and headset 74 can include various components to view, measure, survey and analyze the terrain, topographical features and objects within construction site 70 to define a work area, remote from control station. For example, drone 72 and headset 74 can each include a camera for viewing construction site 70, a range finder for determining distances within construction site 70 and a positioning device for determining locations within construction site 70. In an example, work area 104 can be defined by corners 106A, 106B, 106C and 106D. Though work area 104 is illustrated as comprising a rectilinear area, work area 104 can comprise any shape.

In the illustrated example, construction site 70 can comprise a worksite for any type of operation such as, for example, an open pit mining operation or a building or facility construction site. Each of machines 12, 88, 90, 92 and 94 can be in communication with each other and with a central station, such as control station 50 by way of wireless communication to remotely transmit and receive operational data and instructions. Information relating to the location and operation of machines 12, 88, 90, 92 and 94, as well as terrain features 80, 81, 82, 84 and 86, can be captured via a sensor on drone 72 and/or headset 74, such as a video camera, infrared sensor, thermal sensor, audio recorder, RADAR sensor, LIDAR sensor, optical sensor, or the like. The information captured via the sensors can be transmitted to electronic control unit 54 (FIG. 1) at control station 50 by way of wireless communication. Information captured via the sensors can be filtered, aggregated, and otherwise pre-processed based upon known pre-processing techniques, to eliminate or reduce noise, etc. According to the present disclosure, the information captured via the sensors can be further processed to develop outer boundaries for work area 76 within construction site 70, as well as internal boundaries for avoidance areas. For example, it can be desirable to have paving machine 12 avoid hazardous terrain such as ravine 81, drop-off 82 and depression 86. Likewise, it can be desirable to have paving machine 12 avoid construction areas, such as where facility 102 is being built or where construction material 96 is being moved about. Thus, in an example, boundaries for work area 76 can be established to surround grade 84 where, for example, a parking lot for facility 100 can be constructed. A soil compactor similar to compacting machine 14 can be routed around grade 84 via athe methods described herein to compact the soil before paving operations occur to produce the parking lot. Thereafter, the determined boundary can be analyzed to determine a route for autonomous vehicles through work area 76 to stay within the outer boundaries and out of the avoidance areas.

Ordinarily, one or more operators of paving train 10 would need to physically walk or drive around construction site 70 to electronically mark boundaries for work area 76, thereby requiring a significant amount of time relative to the total paving operation time to plot the work area. For example, all of boundaries 78A-78D might need to be walked by an operator, and then separate internal boundaries around potential hazards, such as construction material 96, facility 102 and depression 86, might need to need to be walked. Also, because vehicles 88, 90 and 94 can frequently move around construction site 70, it can become desirable to mark boundaries for work area 76 multiple times a week or day. Furthermore, the terrain within work area 76 typically needs to be manually reviewed and analyzed relative to the capabilities of individual machines to determine which topographical terrain features, such as step grades and depressions, for a particular vehicle's driving and steering capabilities should be avoided. However, with the present disclosure, a single operator can operate drone 72 or headset 74 to remotely access various portions of construction site 70 and electronically mark landmarks for work area 76 without having to individually and physically visit each location. For example, an operator can manipulate drone 72 remotely to visit the exact locations of structure 102, depression 86, construction material 96 and vehicle 90, for example, to geographically mark their respective locations using, for example, a GPS unit within drone 72. Also, for example, an operator can manipulate headset 74 to virtually visit the locations of structure 102, depression 86, construction material 96 and vehicle 90, for example, using a range finder, inclination sensor and a camera to geographically mark their respective locations using, for example, a GPS unit within headset 74. The geographic locations of the landmarks can be correlated to a coordinate system for an autonomous vehicle, such as compactor 14, to outline a work area and plan a safe driving route.

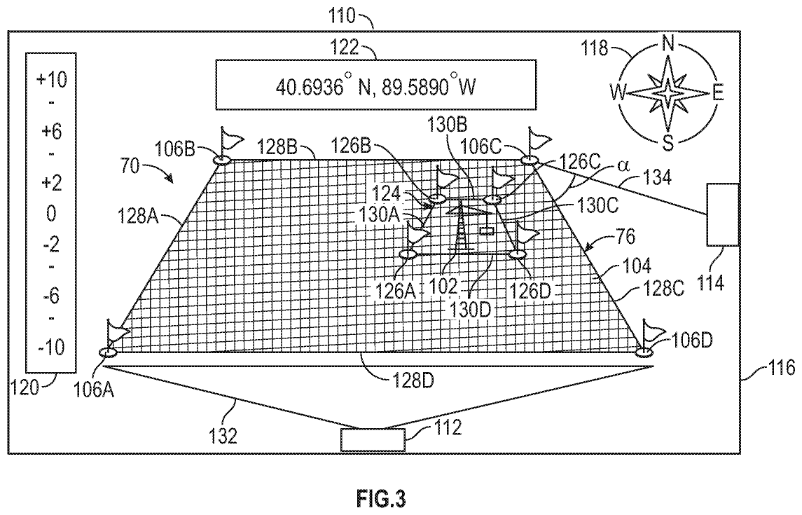

FIG. 3 is a diagrammatic illustration of virtual work area 104 having corners 106A, 106B, 106C and 106D shown in display screen view 110. Work area 104 can comprise a portion of construction site 70 corresponding to, for example, work area 76 of FIG. 2. Display screen view 110 can be generated by one or both of drone 72 and headset 74 of FIG. 2. Drone 72 or headset 74 can comprise camera 112 and range finder 114 mounted relative to lens 116. Display screen view 110 can additionally comprise compass 118, angle indicator 120 and coordinate indicator 122. Comers 106A, 106B, 1060 and 106D can be connected by borders 128A, 128B, 128C and 128D. Work area 104 can further include exclusion area 124, which can be delineated by corners 126A, 126B, 126C and 126D connected by borders 130A, 130B, 130C and 130D. Camera 112 can include viewing area 132 and range finder 114 can emit signal 134.

In an example, virtual work area 104 can be viewed by drone 72. Drone 72 can fly above construction site 70 to visit the locations of work area 76 to define virtual work area 104. Drone 72 can fly autonomously or by operator input at control station 50 to view the topography of construction site 70. An operator can view images from camera 112 obtained by viewing area 132 to determine locations in which equipment of paving train 10, such as compactor 14, should operate and locations that such equipment should avoid. For example, drone 72 can fly directly above or within the vicinity of locations within construction area 70 to identify topographical features for compactor 14 to avoid, such as slope 80, ravine 81 and depression 86. Camera 112 can also view equipment to be avoided such as vehicles 88 and 94 and construction material 96. Thus, an operator can decide that compactor 14 should only operate on grade 84 where a compacting and paving operation can be safely conducted. Camera 112 can also view areas within grade 84 that should be avoided, such as the area immediately surrounding structure 102. As such, an operator can fly drone 72 around work area 76 and establish landmark locations about the periphery of work area 76. Thus, drone 72 can fly directly above corners 106A-106D and at each location the operator can position a virtual marker, such as a flag icon within display screen view 110. Thereafter, drone 72 or control station 50 can connect corners 106A-106D to generate boundaries 128A-128D. Coordinates for corners 106A-106D and boundaries 128A-128D, such as longitude and latitude coordinates obtained by a GPS unit within drone 72, can be recorded in memory 42 of control station 50. Likewise, an operator of drone 72 can fly drone 72 around structure 102 to establish virtual landmarks at corners 126A-126D, which can be used to generate boundaries 126A-126D around structure 102. An operator of drone 72, such as at control station 50, can then generate a plan for equipment to work within boundaries 128A-128D, but outside of boundaries 126A-126D.

Furthermore, drone 72 can scan within virtual work area 104 to determine the topography therein. For example, topographical features within viewing area 132 of camera 112 can be ranged with range finder 114 using signal 134 to determine changes in elevation, which can then be recorded at specific coordinate locations. As such, the actual topography of work area 76 can be correlated to virtual work area 104. The generated virtual topography of virtual work area 104 can be used to route machines, such as compactor 14, through work area 76 in an efficient manner or in a manner to most safely engage slopes and other elevation changes to mitigate risk of, for example, roll over. In particular, drone 72 or control station 50 can include instructions encoded in a machine-readable medium that can analyze three-dimensional terrain or work area 76 to determine grades and abrupt changes in elevation to identify potential hazardous terrain for autonomous vehicles. Furthermore, drone 72 or control station 50 can include stored in memory various performance parameters for different autonomous vehicles, such as how steep of grade such vehicles are capable of traversing, turning radii for such vehicles and the like and instructions encoded in a machine-readable medium that can analyze the determined grades and elevation changes to determine rotes to be avoided for the machines of varying characteristics.

In an example, virtual work area 104 can be viewed by headset 74. Headset 74 can be worn by an operator to change portions of construction site 70 that viewing area 132 of camera 112 encompasses. The head of the operator can be turned or moved to change Where signal 134 of range finder 114 is aiming. Signal 134 can be aimed at different topological features or equipment located within construction site 70 to superimpose virtual work area 104 on top of work area 76. Range finder 114 can be used to determine the distance of targets within viewing area 132. The inclination of headset 74 can be determined, such as by using pose sensors 198 (FIG. 6), to determine the inclination of signal 134 from range finder 114. As such, angle indicator 120 can provide an angle at which signal 134 is being projected relative to level. Combined information from the location of headset 74, such as from a GPS unit, the distance obtained by range finder 114, and the angle indicated by angle indicator 120, the location of features within construction site 70 can be remotely landmarked by an operator standing in a single position within construction site 70. Landmarked positions can be used to delineate work area 76 to generate virtual work area 104. As such, external boundaries of work area 76 can be determined, as well as internal avoidance areas that can surround various equipment, personnel, vehicles and terrain within work site 76 where autonomous Vehicle should avoid.

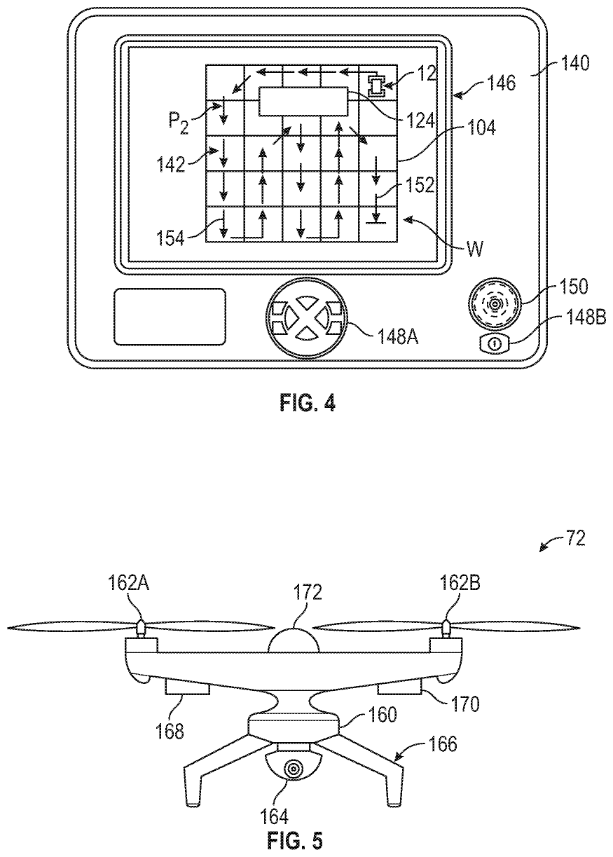

FIG. 4 is a diagrammatic illustration of user interface 140 for any of the construction vehicles or control stations described herein, such as control station 50 of FIG. 1. In various examples, user interface 140 can comprise display device 40 of paving machine 12 or another display device of another machine, such as compactor 14. User interface 140 can show course 142 plotted within work area 104 of FIG. 3. User interface 140 can comprise display screen 146 as well as input devices 148A and 148B. Display screen 146 can be configured to display in an operator perceptible format various types of information about work area 104. Display screen 146 can also display other information, such as a scale, a compass and the like. Input device 148A can comprise, for example, control buttons, and input device 148B can comprise, for example, a power on/off switch. Additionally, output device 150 can be included to, for example, communicate audible signals to an operator.

Control station 50 can be configured to link location data for work area 104 with electronic data indicative of the topography of construction site 70. In the example shown in FIG. 4, work area 104 is partitioned into twenty-five different cells, each having a graphic display state corresponding to a location within work area 104. Greater or fewer cells could be used, in other embodiments. Work area 104 within display screen 146 can include topographical features of construction site 70 to define a terrain map 154. For example, the elevation of locations within work area 104 can be shown using contour lines. As such, display screen 146 can be configured to graphically represent the three-dimensional contours of construction site 70.

Display screen 46 can also show course, or travel path, 142 through each of the cells of work area 104 for an autonomous vehicle, such as compactor 14. Compactor 14 can be shown as an icon on display screen 146. Compactor 14 can be routed one, and typically two or three, passes over a work area in a uniform manner to ensure that every region of the work area is compacted at least once. Thus, execution of the compactor interaction planning algorithm via electronic control station 50 will typically establish a uniform coverage plan or compactor travel plan within work area 104. However, more complex and non-uniform compactor interaction plans can be established.

Control station 50 can obtain the topographic data obtained by drone 72, for example, as well as the boundaries for work area 104 in order to plan course 142 through work area 104 for any of vehicles described herein. For example, control station 50 can route compactor 14 through work area 104 to avoid exclusion area 124. Likewise, course 142 can be plotted by control station 50 or by an operator of control station 50 to avoid topographical features that can potentially be hazardous for the autonomous vehicle. For example, slope 80, ravine 81, drop-off 82 and ditch 98 can be avoided. In particular, control station 50 can determine for specific machines which types of elevation changes in the topography of construction site 70 should be avoided. That is, different types of machines, such as compactor 14 and bulldozer 90, can traverse different uphill and downhill grades. Course 142 can include segments of driving directions 152. According to the planned travel path or course 142 for an autonomous vehicle, such as compactor 14, can be automatically plotted using drone 72 and control station 50 by, for example, first surveying construction site 70 with drone 72, manually determining the boundaries for a work area within the construction site 70 using visual feedback from drone 72, automatically scanning the topography of the work area with drone 72, automatically generating a three-dimensional topographical map of the work area, and plotting a course for the autonomous vehicle through the work area to avoid topography incompatible with the specific autonomous vehicle's capabilities.

FIG. 5 is a schematic illustration of drone, or unmanned aerial vehicle (UAV), 72 for use with the systems and methods described herein. Drone 72 can comprise frame 160, propulsion devices 162A and 162B, camera 164, landing structure 166, locating device 168, ranging device 170 and communication device 172.

In an embodiment, drone 72 can be configured according to the unmanned aerial device described in U.S. Pat. No. 786,105 to Moloney et al., entitled “Gathering Data from Machine Operating at Worksite,” the contents of Which are hereby incorporated in their entirety by this reference.

Drone 72 can be communicatively coupled to control station 50 via a wireless communication link established by communication device 172. In other embodiments, drone 72 can be coupled to control station 50 via wired or tethered coupling that can additionally provide power to drone 72. Drone 72 can also include an internal power source disposed within frame 160, such as a battery.

Upon receipt of power, one or more propulsion devices 162A and 162B can be operated to lift drone 72 to a height above construction site 70. When drone 72 is actuated to the non-operating condition, that is, when the operator of drone 72 switches power off, propulsion devices 162A and 162B can assist in sate landing drone 72 using landing structure 166.

Drone 72 can be configured to communicate with control station 50 using communication device 172 via various means such as service provider systems through satellite communication, terrestrial communication, or may be implemented through use of routers and access points connected to various Digital Subscriber Line Access Multiplexers (DSLAMs) of wired networks. The network can be implemented as one of the different types of networks, such as intranet, local area network (LAN), wide area network (WAN), and the Internet. The network can either be a dedicated network or a shared network, which represents an association of different types of networks that use a variety of protocols, for example, Hypertext Transfer Protocol (HTTP), Transmission Control Protocol/Internet Protocol (TCP/IP), and Wireless Application Protocol (WAP), to communicate with each other.

In another embodiment, drone 72 can be configured to communicate with a mobile device. In an example, the mobile device can be implemented as one of, but not limited to, tablet computer, phablet, mobile phone, personal digital assistance (PDA), smartphone, and the like. In one embodiment, the mobile device can be a non-near field communication (non-NFC) mobile phone. Additionally, the mobile device can include a processor provided to fetch and execute computer-readable instructions and/or inputs from drone 72. The mobile device can be used by the operator of control station 50 to receive and transmit inputs through a network.

Drone 72 can comprise various equipment to view and survey construction site 70 and to determine a route for a machine within work area 104 within construction site 70. Drone 72 can include an image capturing unit such as camera 164 that can be configured to capture one or more images of area work area 76. In an example, camera 164 can be embodied as a digital camera or a video camera that can capture real-time video of work area 76. As such, drone 72 can be operated at a height above construction site 70 to capture topographical features of work area 76, such as slope 80, ravine 81, drop-off 82, grade 84 and depression 86.

Ranging device 170 can be used to determine the position of features within work area 104 relative to drone 72 captured by camera 164. In an embodiment, ranging device 170 can comprise a laser range finder. As such, for topographical features within work area 76, drone 72 can obtain a distance measurement for all or portions of slope 80, ravine 81, drop-off 82, grade 84 and depression 86.

Locating device 168 can be used to determine the position of drone 72 within work area 104. In an embodiment, locating device 168 can comprise a Global Positioning System (GPS) device. Position data, such as latitude and longitude coordinates can be obtained for the topographical features of work area 76 such as slope 80, ravine 81, drop-off 82, grade 84 and depression 86.

For each and all of the topographical features within work area 76, drone 72 can associate a latitude and longitude coordinate position and an elevation position, such as feet above sea level. For example, elevation can be obtained at each topographical feature by subtracting a reading of ranging device 170 from the absolute elevation of drone 72 taken from locating device 168 or by using ranging device 170 to hold drone 72 as a constant relative elevation above construction site 70.

Drone 72 can additionally comprise various computer components for operating camera 164, locating device 168 and ranging device 170. For example, drone 72 can include a controller comprising memory and processors to control movements of drone 72 and execute instructions located on computer readable storage medium for obtaining and processing data collected by camera 164. ranging device 170 and locating device 168 so as to, for example, automatically generate three-dimensional terrain maps and routes through the three-dimensional terrain maps for vehicles of various capabilities.

FIG. 6 is a schematic illustration of an augmented reality headset 74 for use with the systems and methods described herein. Augmented reality headset 74 can comprise a wearable device such as a head-mountable system. Headset 74 can comprise head strap or harness 180, frame 182, goggles 184, display screen 186 comprising lenses 188A and 188B, range finder 190, camera 192, controller 194, speaker 196 and pose sensors 198, projector 200 and positioning device 202.

In an embodiment, headset 74 can be configured according to the systems and devices described in U.S. Pub. No. 2015/0199106 to Johnson, entitled “Augmented Reality Display System,” the contents of which are hereby incorporated in their entirety by this reference.

Headset 76 can be configured to display an image or virtual objects (e.g., graphical media content such as text, images, and/or video) on a substantially transparent display screen 186. The transparency of display screen 186 can permit the wearer to maintain a view of the physical environment, such as construction site 70, while also viewing the virtual text and/or images that are displayed over their physical field of vision to augment the image seen by the wearer, such as flag icons establishing landmarks within work area 76.

Headset 76 can include an adjustable strap or harness 180 that can allow the goggles 184 to be worn about the head of the wearer.

Projector 200 can be configured to direct images onto one or both of lenses 188A and 188B of display screen 186 within a line of sight of the wearer. Image projector 200 can be an optical projection system, light emitting diode package, optical fibers, or other suitable projector for transmitting an image. Display screen 186 can be configured to reflect the image from image projector 209, for example, by a thin film coating, tinting, polarization or the like. Display screen 186 can be a beam splitter, as will be familiar to those of skill in the art. Thus, while display screen 186 can be transparent to most wavelengths of light, it can reflect selected wavelengths such as monochromatic light back to the eyes of the wearer. Such a device is sometimes referred to as an “optical combiner” because it combines two images, the real world physical environment and the image from image projector 200. In still other embodiments, it may be possible to configure the image projector (such a laser or light emitting diode) to draw a raster display directly onto the retina of one or more of the user's eyes rather than projecting an image onto display screen 186. The projected images can appear as an overlay superimposed on the view of the physical environment thereby augmenting the perceived environment.

Headset controller 194 can be provided on headset 76. Headset controller 194 can have wireless communications capabilities such as a transceiver to communicate with control station 50 or other devices and vehicles described herein. Headset controller 194 can operate independently or with other the controllers to control the projection of the images onto display screen 186 and determine the images to be projected by image projector 200.

Headset 76 can also include a headset pose system comprising pose sensors 198 that can be used to determine the orientation and position or pose of the head of the wearer. For example, the headset pose system can include a plurality of headset pose sensors 198 that generate signals that can be used to determine the pose of the wearer's head. In one example, headset pose sensors 198 can be Hall effect sensors that utilize the variable relative positions of a transducer and a magnetic field to deduce the direction, pitch, yaw and roll of the wearer's head. In another example, headset pose sensors 198 can interact with a positioning system such as a global navigation satellite system or a global positioning system to determine the pose of the wearer's head. The data obtained by headset pose sensors 198 can be used to determine the specific orientation of the wearer's field of view relative to work area 104.

As discussed herein, a wearer of headset 74 can view construction site 70 with camera 192 to view landmarks such as boundaries of work area 76 and avoidance areas therein. Camera 192 along with pose sensors 198, range finder 190 and positioning device 202 can analyze the three-dimensional terrain within work area 76 to develop autonomous vehicle routes through the three-dimensional terrain to avoid facilities, equipment, vehicles, personnel and hazardous terrain within work area 76.

### INDUSTRIAL APPLICABILITY

The present disclosure describes various devices, systems and methods for defining work areas for autonomous vehicles, such as machines used in construction sites.

The work areas defined in the present disclosure can be obtained quickly and without the need for multiple operators. For example, a single operator can control a device such as a headset, an unmanned aerial vehicle or drone including an optical surveying device such as a LIDAR system or a stereo video system and a locating device such as a GPS system to scan the terrain of the construction site and identify a work area. The scanned terrain can be converted to a three-dimensional topographical map that can be used to identify terrain within the work area of the construction site that cannot be readily traversed by an autonomous vehicle. The scanned terrain can also be viewed to identify components, such as equipment, structures, personnel, material and the like, within the construction site. Terrain features and components within the work area can be included in exclusion areas where the autonomous vehicle will avoid. Terrain features can be automatically identified and converted to exclusion areas based on driving characteristics of each autonomous vehicle. The work area outside of the exclusion areas can be analyzed to develop driving routes for autonomous vehicles through the construction site. As such, the device or drone incorporating or comprising the optical surveying device can be operated by a single person to view and map an entire construction site without the need for any personnel to walk the boundaries of the construction site and the entire interior, thereby saving time required to walk a construction site and analyze terrain features relative to various vehicle capabilities. Such methods as are described herein are particularly advantageous in paving and soil compactor operations where large areas are being paved that would otherwise require lengthy amounts of time for the perimeter of the work area to be defined and the terrain to be analyzed to determine unsafe terrain features that should be avoided.

What is claimed is:

1. A method for defining a work area for an autonomous industrial vehicle, the method comprising:
positioning an optical surveying device within a work area:
viewing work area landmarks within the work area via the optical surveying device;
establishing virtual work area markers about the work area using the optical surveying device; and
establishing work area boundaries from the work area markers within an image of the optical surveying device.

2. The method of claim 1, wherein viewing work area landmarks within the work area comprises scanning topographical features of the work area.

3. The method of claim 2, further comprising generating a three-dimensional terrain map of the work area from the topographical features.

4. The method of claim 3, wherein establishing work area boundaries further comprises generating exclusion areas within the work area boundaries based on the topological features.

5. The method of claim 4, wherein topological features comprising exclusion areas comprise steep inclines and depressions within the work area that cannot be traversed by the autonomous industrial vehicle.

6. The method of claim 5, wherein generating exclusion areas within the work area boundaries comprises calculating a grade or a change in elevation beyond capabilities of the autonomous industrial vehicle.

7. The method of claim 4, further comprising:
converting the work area boundaries to a coordinate system; and
communicating the work area boundaries to a system including driving directions for the autonomous industrial vehicle.

8. The method of claim 7, further comprising determining a route for the autonomous industrial vehicle within the boundaries of the work area to avoid the exclusion areas.

9. The method of claim 3, wherein the autonomous industrial vehicle comprises a compactor.

10. The method of claim 3, wherein the optical surveying device comprises an aerial drone.

11. The method of claim 10, wherein the aerial drone comprises:
a camera;
a range finder; and
a location sensor.

12. The method of claim 11, wherein scanning topographical features of the work area comprises:
viewing landmarks within the work area with the camera;
reading position signals from the location sensor at the landmarks;
obtaining distance measurements for the landmarks with the range finder; and
correlating a position signal and a distance measurement with each landmark.

13. The method of claim 12, further comprising:
determining an elevation for each landmark from the distance measurement; and
determining a latitude and longitude coordinate for each landmark from the position signal.

14. The method of claim 10, wherein positioning the optical surveying device within the work area comprises flying the aerial drone above the work area.

15. The method of claim 14, further comprising operating the aerial drone from a remote control station located in the work area.

16. The method of claim 15, further comprises:
manually flying the aerial drone to establish the work area boundaries;
automatically generating the three-dimensional terrain map within the work area boundaries; and
automatically generating the exclusion areas within the work area boundaries from the three-dimensional terrain map.

17. The method of claim 2, wherein the optical surveying device comprises a heads-up display of an augmented reality headset configured for wearing by an operator.

18. The method of claim 17, wherein the augmented reality headset comprises:
a camera;
a range finder;
an inclination sensor; and
a locating device.

19. The method of claim 18, wherein the augmented reality headset is operated from a single location within the work area to establish the virtual work area markers.

20. The method of claim 1, wherein the work area landmarks comprise movable construction material located within the work area.
